(19) United States
(12) Patent Application Publication
(10) Pub. No.: US 2025/0377070 A1
(43) Pub. Date: Dec. 11, 2025

(54) ANGLE ADJUSTMENT DEVICE

(71) Applicant: TILTA INC., Burbank, CA (US)

(72) Inventors: Yuqi LIN, Shenzhen (CN); Wenping ZENG, Shenzhen (CN); Kefeng ZHOU, Shenzhen (CN)

(21) Appl. No.: 19/207,163

(22) Filed: May 13, 2025

(30) Foreign Application Priority Data
Jun. 7, 2024 (CN) 2024213146068

(51) Int. Cl. F16M 11/10; F16M 11/04; G03B 17/56

(52) U.S. Cl. CPC F16M 11/105; F16M 11/041; G03B 17/561; F16M 2200/022; F16M 2200/027

(57) ABSTRACT

The present disclosure presents an angle adjustment device, which includes a first installation component, a second installation component, and a locking component. The first installation component includes a first installation base and a first connector. The first connector is attached to the first installation base, and the first installation base is intended for installation on a first external device. The second installation component includes a second installation base and a second connector. The second installation base is designed for installation on a second external device, and the second connector is connected to the second installation base. The first connector is movably mounted on the second connector, enabling relative movement between the first connector and the second connector. The locking component is positioned on either the first connector or the second connector and can move relative to the first connector to restrict the position of the second connector, thereby limiting the relative movement between the first connector and the second connector.

### CROSS-REFERENCE TO RELATED APPLICATIONS

The present application for patent claims priority to and the benefit of pending Chinese Patent Application No. 2024213146068, filed Jun. 7, 2024, and hereby expressly incorporated by reference herein as if fully set forth below in its entirety and for all applicable purposes.

### TECHNICAL FIELD

The present disclosure pertains to the technical field of photography accessories, specifically to an angle adjustment device.

### INTRODUCTION

With the widespread application of photography and videography in daily life, an increasing number of individuals engage in shooting activities. During the shooting process, people often have different composition requirements, necessitating photography professionals to frequently switch between different composition angles. Currently, when photography professionals need to change the composition angle, such as switching from horizontal to vertical shooting, they typically dismount the camera installed horizontally on a fixed device and then remount it vertically to achieve the horizontal-to-vertical switch. This method allows for the adjustment of the camera angle but is relatively inconvenient to use.

### BRIEF SUMMARY

The present disclosure provide an angle adjustment device aimed at addressing the technical problem of inconvenient angle adjustment for various cameras.

The present disclosure provided the following solution:
an angle adjustment device, including:
a first installation component, including a first installation base and a first connector; the first connector is connected to the first installation base, and the first installation base is configured for installation on a first external device;
a second installation component, including a second installation base and a second connector; the second installation base is configured for installation on a second external device, the second connector is connected to the second installation base, and the first connector is movably arranged on the second connector, enabling the first connector and the second connector to move relative to each other;
a locking component, arranged on the first connector or the second connector, and capable of restricting the relative movement between the first connector and the second connector.

### BRIEF DESCRIPTION OF THE DRAWINGS

To elucidate the technical solutions presented in the examples of the present disclosure, the accompanying drawings necessary for describing these examples will be briefly introduced below. It is apparent that the accompanying drawings described herein represent merely some examples of the present disclosure. For those skilled in the art, without the necessity for inventive effort, other drawings can be derived based on the structures depicted in these drawings.

FIG. 1 is a diagram illustrating an angle adjustment device with a shooting equipment installed according to some aspects of the disclosure.

FIG. 2 is a diagram illustrating an exploded diagram of the angle adjustment device according to some aspects of the disclosure.

FIG. 3 is a diagram illustrating a right-side view of the angle adjustment device according to some aspects of the disclosure.

FIG. 4 is a diagram illustrating a cross-sectional view along the A-A direction in FIG. 3 of the disclosure.

FIG. 5 is a diagram illustrating a cross-sectional view along the A-A direction in FIG. 3 of the disclosure.

FIG. 6 is a diagram illustrating another exploded diagram of the angle adjustment device according to some aspects of the disclosure.

FIG. 7 is a diagram illustrating a front view of the angle adjustment device according to some aspects of the disclosure.

FIG. 8 is a diagram illustrating a cross-sectional view along the B-B direction in FIG. 7 of the disclosure.

FIG. 9 is a diagram illustrating a cross-sectional view along the C-C direction in FIG. 7 of the disclosure.

FIG. 10 is a diagram illustrating a first installation component according to some aspects of the disclosure.

FIG. 11 is a diagram illustrating the angle adjustment device in another aspects of the disclosure.

FIG. 12 is a diagram illustrating exploded view of the angle adjustment device of FIG. 11.

### REFERENCE NUMBERS

10. angle adjustment device; 20. shooting equipment;
1. first installation component; 11. first installation base; 12. first connector; 121. projection; 122. opening; 123. third accommodation groove; 124. first side; 125. second side; 126. third side;
2. second installation component; 21. second installation base; 211. base body; 2111. limiting groove; 212. installation part; 2121. sliding groove; 2122. first accommodation groove; 2123. limiting pillar; 2124. quick-release plate; 2125. quick-release base; 2126. installation groove; 2127. connecting section; 2128. second accommodation groove; 213. first locking member; 2131. first locking wrench; 2132. first locking block; 2133. first locking pillar; 214. third locking piece; 2141. second locking wrench; 2142. second locking block; 2143. second locking pillar; 22. second connector; 221. movable groove;
3. locking component; 31. second locking member; 311. second inclined plane; 32. trigger; 321. first inclined plane; 322. trigger knob; 323. trigger block; 324. spring; 33. third locking wrench; 34. third locking pillar; 35. third locking block;
4. guide rail;
5. guide groove;
6. movable plate; 61. bent section; 62. strip-shaped groove.

The objectives, functional features, and advantages of the present disclosure will be further elaborated with reference to the accompanying drawings and in conjunction with exemplary embodiments.

### DETAILED DESCRIPTION

The subsequent passages provide a portrayal of the technical solutions embodied within this disclosure, drawing upon the illustrative figures. It is to be understood that the enumerated examples constitute but a fraction of the broader scope and are not exhaustive. Consequently, any alternative examples derived by ordinary technicians in the relevant field, without the necessity for inventive ingenuity, are encompassed within the protective ambit of this disclosure.

Please be advised that directional terminology (e.g., up, down, left, right, front, rear, etc.) employed in the examples serves exclusively to elucidate the relative positional arrangements and dynamic states among components within a specific orientational framework as depicted in the drawings. In the event of a change in this orientational framework, the directional designations will naturally align with the new configuration.

Furthermore, the utilization of ordinal indicators such as “first,” “second,” and so forth, in this disclosure, is purely for descriptive clarity and cannot be misconstrued as signifying relative significance or implicitly indicating the number of technical features referenced. As such, expressions constrained by such ordinal designations may encompass one or more of the indicated features, either explicitly or implicitly. Moreover, the phrase “and/or” used throughout this document encompasses three distinct possibilities: Taking A and B as examples, it embraces the technical solution exclusive to A, the technical solution exclusive to B, as well as the technical solution that concurrently satisfies both A and B. Additionally, the integration of technical solutions across distinct examples is permissible, albeit contingent upon the feasibility of such integration by ordinary technicians in the field. In instances where the combined technical solutions conflict or are unfeasible, such integrations are deemed non-existent and thereby excluded from the scope of protection afforded by this disclosure.

Currently, during the shooting process, photographers can hold the shooting equipment 20 vertically, horizontally, or at other angles to achieve multi-angle shooting compositions. Alternatively, some photographers may also use photography accessories to assist with horizontal and vertical shooting. For example, the current horizontal and vertical shooting adjustment structure includes a quick-release component with a groove body and a fixing device with a bottom arm and a side wall. The quick-release component is used to connect the shooting equipment 20. When the quick-release component is installed on the bottom arm, it is in horizontal shooting mode; when installed on the side arm, it is in vertical shooting mode. For specific details, refer to Chinese Patent No. 2022233596504. It should be understood that the shooting equipment 20 in this text includes but is not limited to cameras or mobile phones, or cameras or mobile phones equipped with a full cage, half cage, or mounting plate.

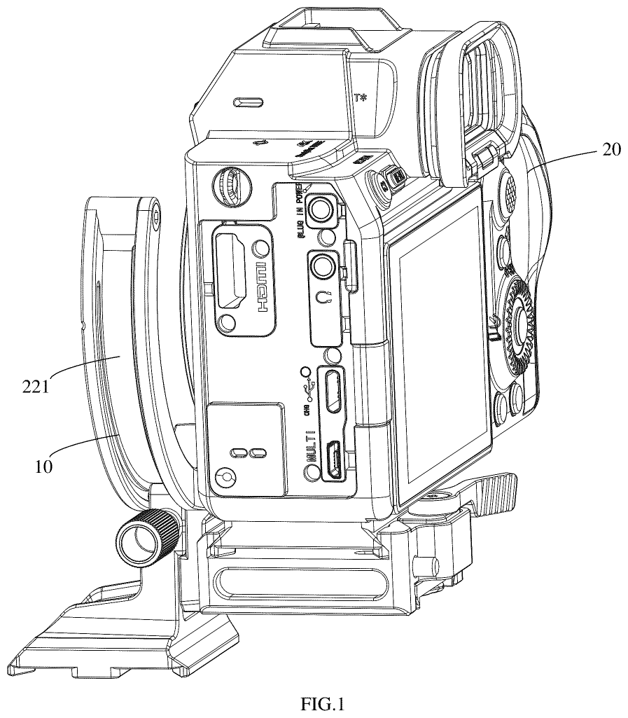

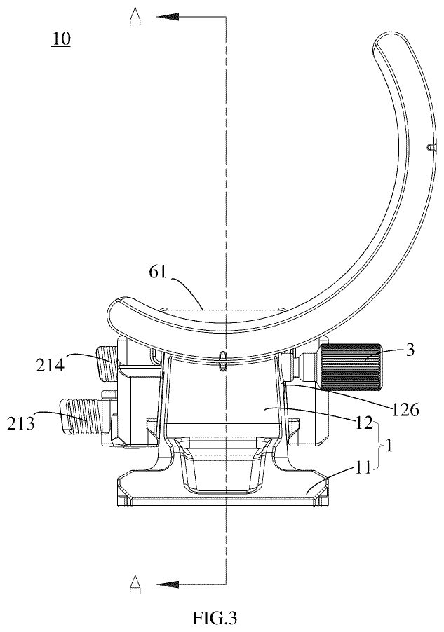

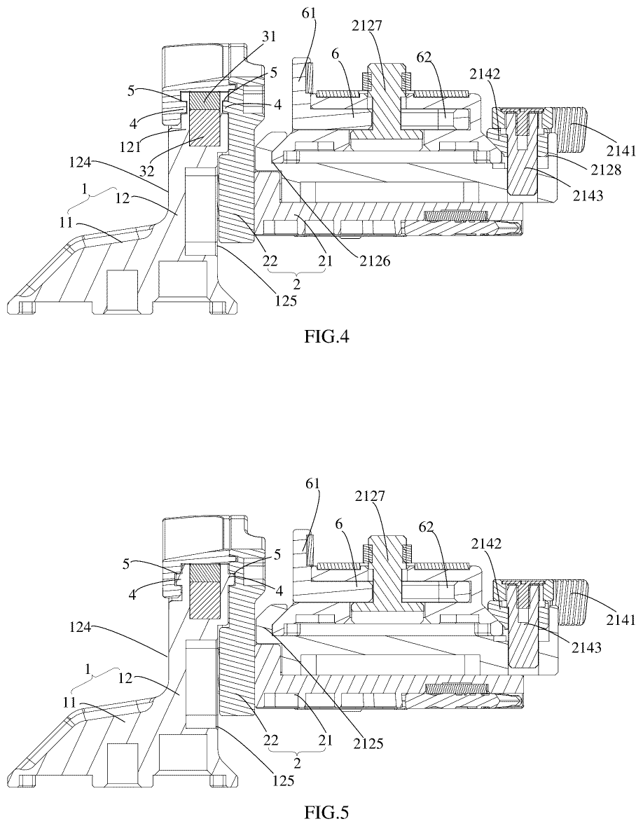

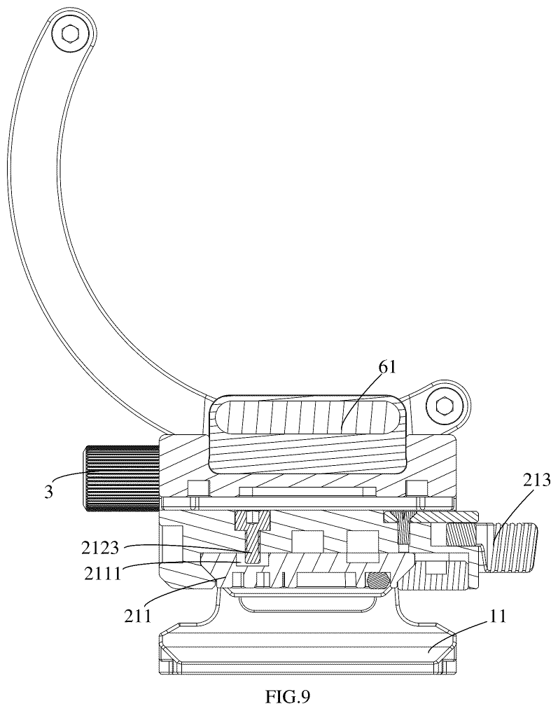

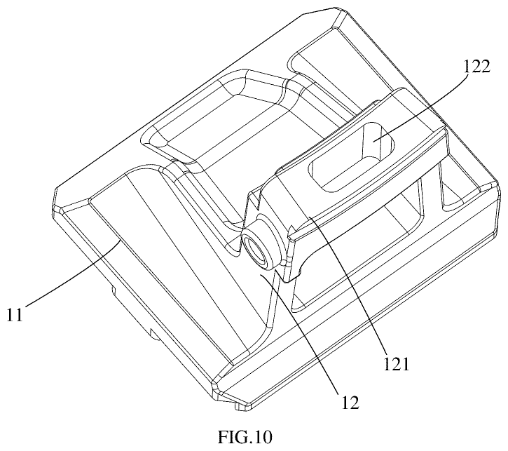

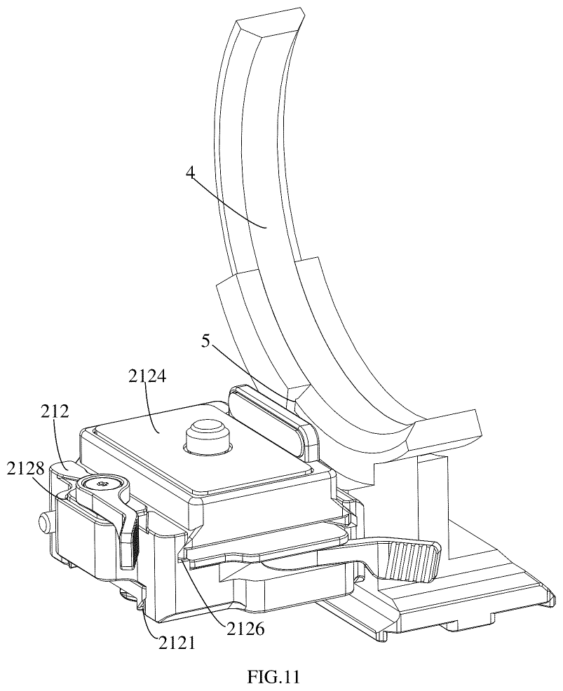

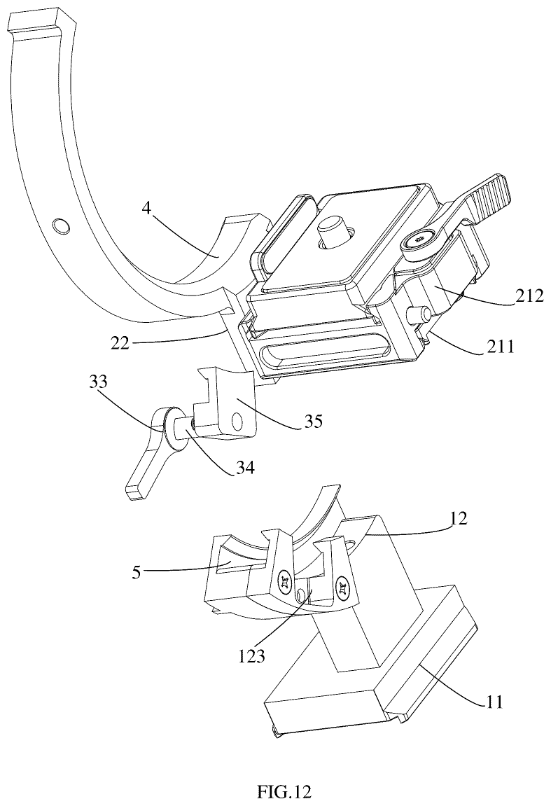

Referring to FIGS. 1-12, the disclosure presents an angle adjustment device 10, which includes a first installation component 1, a second installation component 2, and a locking component 3. Referring to FIG. 3, the first installation component 1 includes a first installation base 11 and a first connector 12. The first connector 12 is connected to the first installation base 11, and the first installation base 11 is configured for installation on a first external device (e.g., a tripod kit). Referring to FIG. 4, the second installation component 2 includes a second installation base 21 and a second connector 22. The second installation base 21 is configured for installation on a second external device (e.g. a camera kit), and the second connector 22 is connected to the second installation base 21. The first connector 12 is movably mounted on the second connector 22, enabling relative movement between the first connector 12 and the second connector 22. The locking component 3 is positioned on either the first connector 12 or the second connector 22 and is used to restrict the relative movement between the first connector 12 and the second connector 22.

In the disclosure, the first connector 12 and the second connector 22 can be locked or loosened by the locking component 3, allowing the second connector 22 to rotate relative to the first connector 12. This further enables the second installation base 21 to rotate relative to the first installation base 11, thereby adjusting the angle of the second external device mounted on the second installation base 21. Therefore, when photographers or videographers require different composition perspectives, they can lock or loosen the first connector 12 and the second connector 22 at different angles using the locking component 3 to facilitate subsequent shooting.

In some aspects, the first external device includes fixing devices such as tripods, stabilizers, etc. The second external device includes the shooting equipment 20, which specifically includes but is not limited to cameras or mobile phones, or devices equipped with full cages, half cages, or mounting plates for cameras or mobile phones.

On another aspect, the locking component 3 in the disclosure is positioned on the side of the second connector 22 for easy operation by the user.

With reference to FIGS. 3-5 and 11, the movable cooperation between the first connector 12 and the second connector 22 can be achieved through the cooperation of a guide rail 4 and a guide groove 5. The positions of the guide rail 4 and the guide groove 5 can be flexibly arranged, with one of the first connector 12 and the second connector 22 including the guide rail 4 and the other including the guide groove 5. For example, in one aspect, with reference to FIGS. 4 and 11-12 the first connector 12 includes the guide groove 5, and the second connector 22 includes the guide rail 4. In some aspects, the guide groove 5 of the first connector 12 can enclose the guide rail 4 of the second connector 22 from the outside, as shown in FIG. 12. In some aspects, the locking component 3 is connected to the first connector 12 and includes a third locking wrench 33, a third locking pillar 34, and a third locking block 35. The first connector 12 is provided with a third accommodation groove 123, in which the third locking block 35 is accommodated. The third locking pillar 34 is connected to both the third locking wrench 33 and the third locking block 35. The third locking wrench 33 is disposed on the first connector 12 and can drive the third locking block 35 to lock the guide rail 4 in the guide groove 5. In some aspects, when the third locking wrench 33 is rotated, the third locking block 35 moves closer to the guide groove 5, thereby compressing the guide rail 4.

Alternatively, as illustrated in FIGS. 3-4 and 10, the first connector 12, which includes the guide groove 5, can also have a configuration where the first connector 12 includes a projection 121. The side wall of the projection 121 is equipped with the guide groove 5. For the second connector 22 that includes the guide rail 4, the second connector 22 has a movable groove 221 (e.g., a curved guide channel). The inner wall of the movable groove 221, corresponding to the guide groove 5, is provided with the guide rail 4, which slides within the guide groove 5. Additionally, the top of the projection 121 features an opening 122, through which a portion of the locking component 3 can be exposed to act on the wall of the movable groove 221. Specifically, both side walls of the projection 121 are provided with guide grooves 5, and the inner wall of the movable groove 221, corresponding to both side walls of the projection 121, is equipped with guide rails 4, ensuring smooth sliding for the first connector 12 and the second connector 22. It should be noted that In the example, the locking component 3 is depicted as being connected to the first connector 12. the locking component 3 includes a second locking member 31 and a trigger 32, the second locking member 31 is provided on the first connector 122. the first connector 12 includes a first side 124, a second side 125, and a third side 126, and the first side 124 is located on a side of the first connector 12 toward the first installation base 11; the second side 125 is located on a side of the first connector 12 away from the first installation base 11, and the third side 126 is provided between the first side 124 and the second side 125; wherein the trigger 32 is movably connected with the third side 126 of the first connector 12; in response to the movement of the trigger 32 relative to the first connector 12, the trigger 32 is configured to drive the second locking member 31 to protrude from the opening 122, thereby abutting against an inner side of the movable groove 221.

In another aspect, as shown in FIGS. 3, 5, and 10, the first connector 12 includes the guide rail 4, while the second connector 22 includes the guide groove 5. In some aspects, the locking component 3 can be positioned on either the first connector 12 or the second connector 22. First, considering the case where the locking component 3 is provided on the first connector 12, the guide rail 4 has an opening 122, and the locking component 3 is mounted on the first connector 12, with a portion of its structure exposed through the opening 122 to act on the wall of the guide groove 5. Specifically, In some aspects, the first connector 12 can also include a projection 121, with guide rails 4 arranged on both sides of the projection 121. The second connector 22 can include a movable groove 221, with guide grooves 5 positioned in the movable groove 221 corresponding to the guide rails 4 on both sides of the projection 121. The locking component 3 includes a second locking member 31 and a trigger 32, the first connector 12 is provided with an opening 122, the second locking member 31 is provided on the first connector 122. the first connector 12 includes a first side 124, a second side 125, and a third side 126, and the first side 124 is located on a side of the first connector 12 toward the first installation base 11; the second side 125 is located on a side of the first connector 12 away from the first installation base 11, and the third side 126 is provided between the first side 124 and the second side 125; wherein the trigger 32 is movably connected with the third side 126 of the first connector 12; in response to the movement of the trigger 32 relative to the first connector 12, the trigger 32 is configured to drive the second locking member 31 to protrude from the opening 122, thereby abutting against an inner side of the movable groove 221.

Second, considering the case where the locking component 3 is disposed on the second connector 22, the locking component 3 is mounted on the second connector 22 and includes a third locking wrench 33, a third locking pillar 34, and a third locking block 35. The second connector 22 is provided with a third accommodation groove 123, in which the third locking block 35 is housed. The third locking pillar 34 is connected to both the third locking wrench 33 and the third locking block 35. The third locking wrench 33 is mounted on the second connector 22 and can drive the third locking block 35 to lock the guide rail in the guide groove.

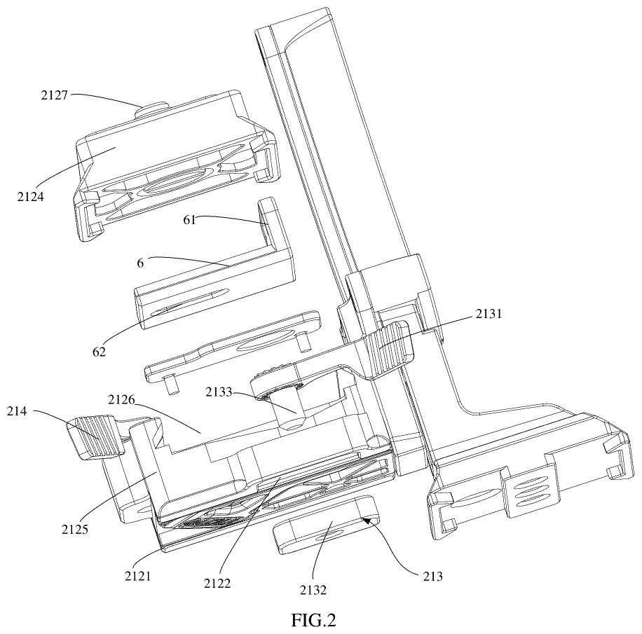

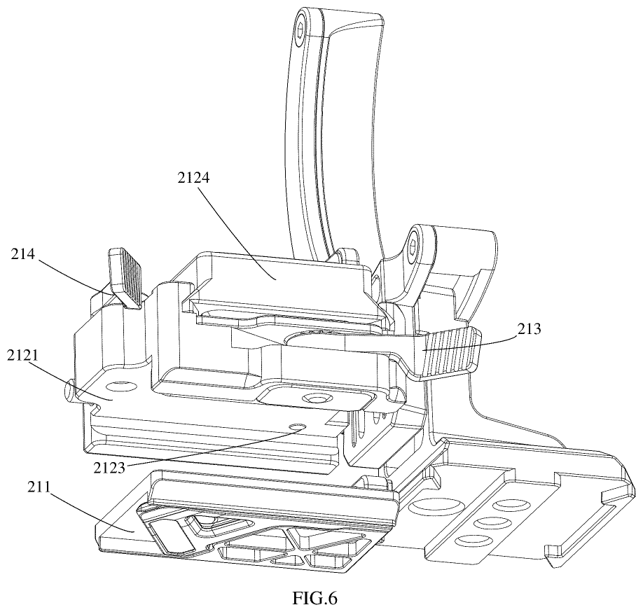

In other aspects, the angle adjustment device 10 in this disclosure can be applied to various models of shooting equipment 20. With reference to FIGS. 2 and 6, the second installation base 21 includes a base body 211, an installation part 212, and a first locking member 213. The second connector 22 is connected to the base body 211. The installation part 212 is intended for installing the second external device and is movably connected to the base body 211. The first locking member 213 is positioned on the installation part 212 to lock the installation part 212 to the base body 211. With this configuration, the installation part 212 can slide along the base body 211 to different positions to accommodate different shooting equipment 20. Once adjusted to the appropriate position, the base body 211 can be locked by the first locking member 213.

Specifically, with reference to FIG. 6, the side of the installation part 212 facing the base body 211 is equipped with a sliding groove 2121, in which the base body 211 is installed. The first locking member 213 can lock the base body 211. Specifically, both sides of the base body 211 have inclined planes, and the inner wall of the sliding groove 2121 also has inclined planes that cooperate with the inclined planes on both sides of the base body 211. The first locking member 213 can lock onto the inclined planes of the base body 211. Specifically, the first locking member 213 includes a first locking wrench 2131, a first locking block 2132, and a first locking pillar 2133. The installation part 212 is provided with a first accommodation groove 2122, in which the first locking block 2132 is accommodated. The first locking pillar 2133 is threadedly connected to both the first locking block 2132 and the first locking wrench 2131. When the first locking wrench 2131 is rotated, the first locking block 2132 moves closer to the installation part 212, thereby compressing the base body 211. Furthermore, the base body 211 is provided with a limiting groove 2111, and the side of the installation part 212 facing the base body 211 is equipped with a limiting pillar 2123.

Referring to FIG. 2, in some aspects, the installation part 212 includes a quick-release plate 2124 and a quick-release base 2125. The quick-release base 2125 is provided with a sliding groove 2121, and an installation groove 2126 is formed on the side of the quick-release base 2125 opposite to the sliding groove 2121. The quick-release plate 2124 is installed in the installation groove 2126. The angle adjustment device 10 further includes a movable plate 6, which is movably connected to the quick-release plate 2124 and is bent away from the second installation base 21 at the end close to the second connector 22 to form a bent section 61. In some aspects, the bent section 61 can support the shooting equipment 20, further enabling the shooting equipment 20 to be stably installed on the quick-release plate 2124, thereby preventing deflection.

Furthermore, for the installation of the quick-release plate 2124, it can be locked by a third locking piece 214. Specifically, the third locking piece 214 can be locked on the inclined plane of the quick-release plate 2124. Specifically, the third locking piece 214 includes a second locking wrench 2141, a second locking block 2142, and a second locking pillar 2143. The installation part 212 is provided with a second accommodation groove 2128, in which the second locking block 2142 is accommodated. The second locking pillar 2143 is threadedly connected to both the second locking block 2142 and the second locking wrench 2141. When the second locking wrench is rotated, the second locking block 2142 moves closer to the installation part 212, thereby compressing the quick-release plate 2124.

Referring to FIG. 2, the quick-release plate 2124 is provided with a connecting section 2127 for installing a second external device, and the movable plate 6 is provided with a strip-shaped groove 62 (e.g., a slot). The connecting section 2127 is inserted through the strip-shaped groove 62. With this arrangement, when installing shooting equipment 20 of different models and sizes, the movable plate 6 can be pulled out from the quick-release plate 2124 by a certain distance to support different shooting equipment 20.

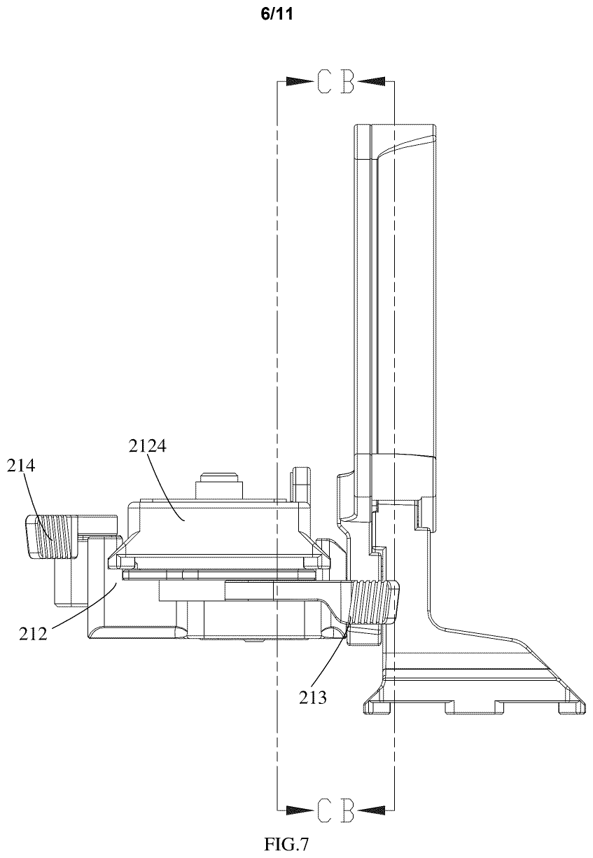

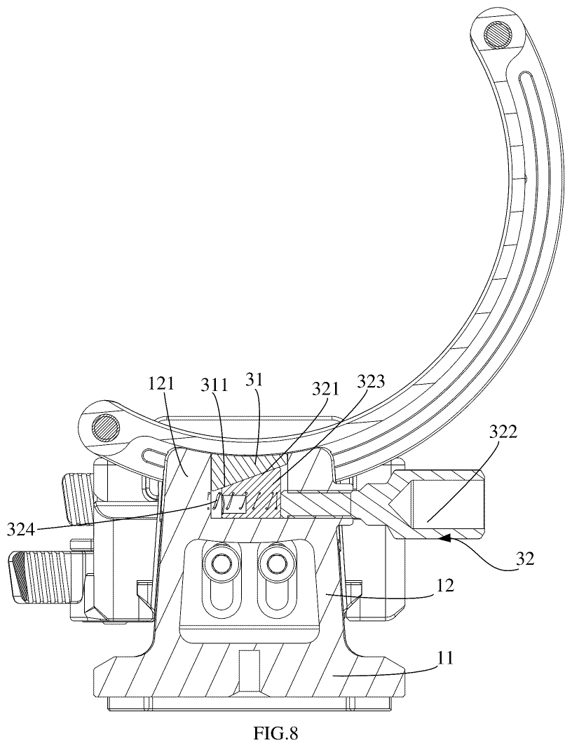

Referring to FIGS. 7-10, the locking component 3 described herein includes a second locking member 31 and a trigger 32. The first connector 12 features an opening 122, and the second locking member 31 is mounted on the first connector 12 and can be exposed through the opening 122. The trigger 32 is elastically connected to the first connector 12 and can move relative to the first connector 12 to activate the first locking member 213 to protrude from the opening 122, thereby locking the second connector 22. In some aspects, by rotating the trigger 32, the second locking member 31 can be moved relative to the opening 122, thereby abutting against or moving away from the second connector 22, thus locking and unlocking the first connector 12 and the second connector 22.

Specifically, the trigger 32 is equipped with a first inclined plane 321, and the second locking member 31 is provided with a second inclined plane 311. The first inclined plane 321 can abut against the second inclined plane 311 to drive the second locking member 31 to protrude from the opening 122. In some aspects, by rotating the trigger 32, the first inclined plane 321 of the trigger 32 can abut against the second inclined plane 311 of the second locking member 31, thereby activating the second locking member 31 to protrude from the opening 122 and abut against the second connector 22.

In more detail, the trigger 32 includes a trigger knob 322 and a trigger block 323. The trigger block 323 is elastically connected to the first connector 12 and is equipped with the first inclined plane 321. The trigger knob 322 is threadedly connected to the first connector 12 and can rotate relative to the first connector 12 to activate the movement of the trigger block 323, thereby driving the movement of the second locking member 31. It should be noted that the trigger block 323 can be connected to the first connector 12 through a spring 324.

In other aspects, the locking component 3 is connected to the first connector 12 and includes a third locking wrench 33, a third locking pillar 34, and a third locking block 35. The first connector 12 is provided with a third accommodation groove 123, in which the third locking block 35 is housed. The third locking pillar 34 is connected to both the third locking wrench 33 and the third locking block 35. The third locking wrench 33 is mounted on the first connector 12 and can drive the third locking block 35 to lock the guide rail 4 in the guide groove 5. In some aspects, with this configuration, when the third locking wrench 33 is rotated, the third locking block 35 moves closer to the guide groove 5, thereby compressing the guide rail 4. It should be understood that when the positions of the guide rail 4 and the guide groove 5 are reversed, the third locking wrench 33, the third locking pillar 34, the third locking block 35, and the third accommodation groove 123 can also be mounted on the second connector 22, and the locking principle remains the same, which will not be elaborated here.

It is emphasized that the aforementioned embodiments serve as preferred illustrations and do not constitute limitations on the scope of the patent claims presented herein. Any structural modifications that are deemed equivalent, based on the disclosure and drawings of this disclosure, or their direct/indirect disclosure in related technical domains, fall within the ambit of patent protection afforded to this disclosure, in line with its underlying concept.

What is claimed is:

1. An angle adjustment device, comprising:
a first installation component, comprising a first installation base and a first connector, wherein the first connector is connected to the first installation base, and the first installation base is configured for installation on a first external device;
a second installation component, comprising a second installation base and a second connector, wherein the second installation base is configured for installation of a second external device, the second connector is connected to the second installation base, and the first connector is movably arranged on the second connector, enabling the first connector and the second connector to move relative to each other; and
a locking component, provided on the first connector or the second connector, and configured to restrict a relative movement between the first connector and the second connector.

2. The angle adjustment device according to claim 1, wherein the first installation base is provided on a side of the first connector away from the second installation base, and the second installation base is provided on a side of the second connector away from the first installation base.

3. The angle adjustment device according to claim 1, wherein one of the first connector and the second connector comprises a guide rail, and an another of the first connector and the second connector comprises a guide groove; and
wherein the guide rail is slidably arranged in the guide groove.

4. The angle adjustment device according to claim 3, wherein the first connector comprises the guide groove, and the second connector comprises the guide rail.

5. The angle adjustment device according to claim 4, wherein the first connector comprises a projection;
wherein at least one side wall of the projection comprises the guide groove, and the second connector comprises a movable groove; and
wherein at least one inner wall of the movable groove corresponding to the guide groove comprises the guide rail.

6. The angle adjustment device according to claim 3, wherein the first connector comprises the guide rail, and the second connector comprises the guide groove.

7. The angle adjustment device according to claim 6, wherein the first connector comprises a projection; and at least one side wall of the projection comprises the guide rail;
wherein the second connector comprises a movable groove; and at least one inner wall of the movable groove comprises the guide groove corresponding to the guide rail.

8. The angle adjustment device according to claim 1, wherein the second installation base comprises a base body, an installation part, and a first locking member; and
wherein the second connector is connected to the base body, the installation part is configured for installation of a second external device and the installation part is movably connected to the base body, and the first locking member is provided on the installation part and is configured for locking the installation part to the base body.

9. The angle adjustment device according to claim 8, wherein a side of the installation part facing the base body is provided with a sliding groove; and
wherein the base body is installed in the sliding groove and cooperates with an inclined plane of the sliding groove, and the first locking member is configured to lock the base body;
in response to an actuation of the first locking member, a position of the installation part relative to the second connector is capable of movement.

10. The angle adjustment device according to claim 9, wherein the installation part comprises a quick-release plate and a quick-release base;
wherein the quick-release base is provided with the sliding groove, a side of the quick-release base opposite to the sliding groove is provided with an installation groove, and the quick-release plate is installed in the installation groove; and
wherein the angle adjustment device further comprises a movable plate, the movable plate is movably connected to the quick-release plate, and an end of the movable plate proximal to the second connector is bent away from the second installation base to form a bent section.

11. The angle adjustment device according to claim 10, wherein the quick-release plate is provided with a connecting section for installing the second external device, the movable plate is provided with a strip-shaped groove, and the connecting section passes through the strip-shaped groove.

12. The angle adjustment device according to claim 4, wherein the locking component is arranged on the first connector and comprises a third locking wrench, a third locking pillar, and a third locking block; wherein the first connector is provided with a third accommodation groove; and
wherein the third locking block is accommodated in the third accommodation groove, the third locking pillar is connected to both the third locking wrench and the third locking block, the third locking wrench is arranged on the first connector, and the third locking wrench is configured to drive the third locking block to lock the guide rail in the guide groove.

13. The angle adjustment device according to claim 6, wherein the locking component is arranged on the second connector and comprises a third locking wrench, a third locking pillar, and a third locking block;
wherein the second connector is provided with a third accommodation groove; and
wherein the third locking block is accommodated in the third accommodation groove, the third locking pillar is connected to both the third locking wrench and the third locking block, the third locking wrench is arranged on the second connector, and the third locking wrench can drive the third locking block to lock the guide rail in the guide groove.

14. The angle adjustment device according to claim 5, wherein the locking component is provided on the first connector and comprises a second locking member and a trigger; and
wherein the first connector is provided with an opening, the second locking member is provided on the first connector, and the trigger is elastically connected to the first connector;
in response to a movement of the trigger relative to the first connector, the second locking member is configured to protrude from the opening, thereby locking the guide rail of the second connector in the guide groove of the first connector.

15. The angle adjustment device according to claim 14, wherein the opening is provided on a top side of the projection,
wherein the first connector comprises a first side, a second side, and a third side, and the first side is located on a side of the first connector toward the first installation base; the second side is located on a side of the first connector away from the first installation base, and the third side is provided between the first side and the second side; wherein the trigger is movably connected with the third side of the first connector;
in response to the movement of the trigger relative to the first connector, the trigger is configured to drive the second locking member to protrude from the opening, thereby abutting against an inner side of the movable groove.

16. The angle adjustment device according to claim 14, wherein the trigger comprises trigger knob and a trigger block, the trigger knob is movably connected to the first connector, and the trigger block is elastically connected to the first connector;
wherein the trigger block is provided with a first inclined plane, the second locking member is provided with a second inclined plane;
in response to the movement of the trigger knob relative to the first connector, the first inclined plane of the trigger block is configured to abut against the second inclined plane of the second locking member, driving the second locking member to protrude from the opening.

17. The angle adjustment device according to claim 7, wherein the locking component is provided on the first connector and comprises a second locking member and a trigger; and
wherein the first connector is provided with an opening, the second locking member is provided on the first connector, the trigger is elastically connected to the first connector;
in response to a movement of the trigger relative to the first connector, the second locking member is configured to protrude from the opening, thereby locking the guide rail of the first connector in the guide groove of the second connector.

18. The angle adjustment device according to claim 17, wherein the opening is provided on a top side of the projection,
wherein the first connector comprises a first side, a second side, and a third side, and the first side is located on a side of the first connector toward the first installation base; and the second side is located on a side of the first connector away from the first installation base, the third side is provided between the first side and the second side; wherein the trigger is movably connected with the third side of the first connector;
in response to the movement of the trigger relative to the first connector, the trigger is configured to drive the second locking member to protrude from the opening, thereby abutting against an inner side of the movable groove.

19. The angle adjustment device according to claim 18, the trigger comprises a trigger knob and a trigger block, the trigger block is elastically connected to the first connector and is provided with a first inclined plane, the second locking member is provided with a second inclined plane;
in response to the movement of the trigger knob relative to the first connector, the first inclined plane of the trigger block is configured to abut against the second inclined plane of the second locking member, thereby abutting against an inner side of the movable groove.
